(19) United States
(12) Patent Application Publication
(10) Pub. No.: US 2020/0380233 A1
(43) Pub. Date: Dec. 3, 2020

(54) ULTRASOUND RECEIVE SIGNAL CHAIN ARCHITECTURE WITH PROGRAMMABLE ANALOG INTEGRATOR

(71) Applicant: Analog Devices International Unlimited Company, Limerick (IE)

(72) Inventors: Sudarshan ONKAR, Bangalore (IN); Vinayak AGRAWAL, Uttar Pradesh (IN); Ameya PANGARKAR, Bangalore (IN); Gauri MITTAL, Chandanagar (IN); Kenneth M. FEEN, Hospital (IE); John A. CLEARY, Kilmallock (IE)

(73) Assignee: Analog Devices International Unlimited Company, Limerick (IE)

(21) Appl. No.: 16/835,739

(22) Filed: Mar. 31, 2020

Related U.S. Application Data
(60) Provisional application No. 62/854,666, filed on May 30, 2019.

(51) Int. Cl. G06K 9/00; H04B 11/00

(52) U.S. Cl. CPC G06K 9/0002; G06K 9/00973; H04B 11/00

(57) ABSTRACT

Hardware architectures for ultrasonic front-end receivers used in ultrasonic sensing applications are disclosed. An example ultrasonic receiver may include a plurality of ultrasonic sensor elements. A given ultrasonic sensor element may be configured to detect an ultrasonic signal/wave that has interacted with an object being analyzed, such as a finger, if determining a fingerprint is the target of the ultrasonic sensing. The ultrasonic sensor element is further configured to generate an electrical signal indicative of the ultrasonic signal that has been detected. In contrast to conventional implementations, the electrical signal is integrated in an analog domain, prior to being converted to digital domain for further processing. Various embodiments of the ultrasonic receivers disclosed herein may benefit from one or more of reduced power consumption, reduced die area requirements, and reduced cost due to the use of a more efficient architecture.

### CROSS REFERENCE TO RELATED APPLICATIONS

This application is related to U.S. Patent Application No. 62/854,666, filed May 30, 2019, titled “ULTRASOUND RECEIVE SIGNAL CHAIN ARCHITECTURE WITH PROGRAMMABLE ANALOG INTEGRATOR,” the disclosure of which is hereby incorporated by reference herein in its entirety.

### TECHNICAL FIELD OF THE DISCLOSURE

The present disclosure relates generally to electronic devices and, more specifically, to ultrasonic sensing.

### BACKGROUND

Ultrasonic sensing (e.g., sensing using devices configured to detect ultrasound signals/waves) can be used in a variety of applications. One example is fingerprint sensing. Although there are many approaches to fingerprint sensing, such as optical, capacitive, and direct pressure, ultrasonic fingerprint sensing is particularly attractive because it is resilient against the negative effects of dirt, grease, sweat, particles, and other contaminants that may affect measurements using other approaches. In addition, ultrasonic fingerprint sensors may be used to capture three-dimensional (3D) images of fingerprints, increasing security of the fingerprint identification compared to, e.g., capacitive fingerprint sensors which can only capture two-dimensional (2D) images. Furthermore, ultrasonic sensing can operate through thin materials such as glass, aluminum, or plastic. Therefore, ultrasonic sensors can advantageously be embedded under the case or under the display of a device, e.g., of a mobile phone or tablet.

Ultrasonic sensing makes use of ultrasonic sound waves, typically with frequencies higher than the upper audible limit of human hearing, e.g., higher than about 20 kilohertz (kHz). An ultrasonic sensor system (which may also be referred to, interchangeably, as an “ultrasonic scanner”) may include a transmitter and a receiver. The transmitter is configured to transmit an ultrasonic signal, e.g., an ultrasonic pulse, against an object being analyzed (e.g., a finger, if fingerprint is the desired object of the ultrasound sensing) that has been placed over the scanner. Some of the pressure of the transmitted ultrasonic signal may be absorbed by the object, and some of it may be reflected back to the scanner. The receiver may include an array of ultrasound sensor elements, configured to detect the ultrasonic signal incident thereon. Because the ultrasonic signal detected by the receiver is indicative of how the ultrasonic signal transmitted by the transmitter has interacted with the object, analyzing the detected ultrasound signal may provide information about the object being analyzed. For example, the detected ultrasonic signal may be analyzed to map ridges, valleys, pores and other details that are unique to each fingerprint. Scanning for longer periods of time may allow for additional depth data to be captured, resulting in a highly detailed 3D reproduction of the scanned fingerprint or resulting in other additional data about the object being analyzed.

A variety of factors can affect the cost, quality and robustness of an ultrasonic scanner. Physical constraints such as space/surface area and power consumption can pose further constraints to the ultrasonic scanner requirements or specifications and, thus, trade-off and ingenuity have to be exercised.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 provides a block diagram illustrating an example ultrasonic sensor system, according to some embodiments of the present disclosure;

FIG. 2 provides a schematic illustration of an ultrasonic device with signal integration in analog domain, according to some embodiments of the present disclosure; and

FIG. 3 provides a schematic illustration of different locations of time windows used in performing signal integration in analog domain, according to some embodiments of the present disclosure.

### DESCRIPTION OF EXAMPLE EMBODIMENTS OF THE DISCLOSURE

Overview

The systems, methods and devices of this disclosure each have several innovative aspects, no single one of which is solely responsible for the all of the desirable attributes disclosed herein. Details of one or more implementations of the subject matter described in the present disclosure are set forth in the description below and the accompanying drawings.

For purposes of illustrating ultrasonic receivers with signal integration in analog domain, proposed herein, it might be useful to first understand phenomena that may come into play when ultrasonic sensing is involved. The following foundational information may be viewed as a basis from which the present disclosure may be properly explained. Such information is offered for purposes of explanation only and, accordingly, should not be construed in any way to limit the broad scope of the present disclosure and its potential applications.

As described above, an ultrasonic scanner may include an ultrasonic transmitter and an ultrasonic receiver. The ultrasonic transmitter may include a digital-to-analog converter (DAC), configured to generate an electrical signal which is then provided to a driver of the transmitter, enabling the transmitter to transmit an ultrasonic signal in the form of acoustic waves, indicative of the electrical signal generated by the DAC. The acoustic waves travel towards the surface of the transmitter, or a device in which the transmitter is included (e.g., towards the surface of a glass of a mobile phone or a tablet), and then further towards an object to be sensed, e.g., to a finger in case the ultrasonic scanner is used for fingerprint sensing. Some of the acoustic waves that were incident on and interacted with the object are reflected back towards the ultrasonic scanner, some of which waves become incident on the ultrasonic receiver which is normally placed proximate to the transmitter. Reflection of the acoustic waves may be indicative of the fingerprint. For example, less acoustic waves may be reflected from a finger ridge of a finger touching the surface because the finger ridge may absorb some energy. The ultrasonic receiver, also sometimes referred to as an “ultrasonic front-end receiver,” may include a plurality of ultrasonic sensor elements, e.g., a plurality of piezoelectric transducer (PZT) sensor elements, arranged in an array, e.g., arranged in a 2D matrix of rows and columns. At least some of the acoustic waves that have interacted with the finger and have been reflected back towards the scanner may be detected by the ultrasonic sensor elements (which may also be referred to as “pixels” of the scanner). Each ultrasonic sensor element may be configured to generate an electrical signal, in analog domain, that represents the detected acoustic wave.

In conventional ultrasonic scanners, the analog electrical signals representing the detected acoustic waves are amplified by an amplifier (e.g., by a low-noise amplifier (LNA)), filtered (e.g., to reject aliases), and subsequently sampled onto an analog-to-digital converter (ADC). The digital signals generated by the conversion process of the ADC are then integrated and analyzed to determine the fingerprint. Inventors of the present disclosure realized that such a process is suboptimal for several reasons. One reason is that the conventional process places severe demands on the speed and resolution of the ADC. In particular, because the ultrasound signals are high-frequency signals (e.g., signals with frequencies on the order of a few megahertz (MHz)), the ADC configured to convert the electrical signals representing such ultrasound signals has to operate at a correspondingly high clock rate, which results in a power consumption that may be prohibitively large for some applications such as battery-powered mobile devices. In addition, conventional ultrasonic scanners require one ADC per single active LNA, which results in large die area requirements. Still further, many conventional ultrasonic scanners require significant computational and memory resources. Improvements with respect to at least some of these challenges of ultrasonic sensing applications would be desirable.

Embodiments of the present disclosure provide hardware architectures for ultrasonic front-end devices, e.g., ultrasonic front-end receivers, used in ultrasonic sensing applications. An example ultrasonic receiver may include a plurality of ultrasonic sensor elements such as, but not limited to, PZT sensor elements. A given ultrasonic sensor element may be configured to detect/receive, through an ultrasonic transmitting media, an ultrasonic signal/wave that has interacted with an object being analyzed (e.g., with a finger, if determining a fingerprint is the target of the ultrasonic sensing). The ultrasonic sensor element is further configured to generate an electrical signal indicative of the ultrasonic signal that has been detected/received. In contrast to conventional implementations, the electrical signal is integrated in an analog domain, optionally with programmable integration time, prior to being converted, by an ADC, to digital domain for further processing. The ADC is configured to convert to the digital domain the analog result of the integration. The digital signal output by the ADC may then be used to determine one or more characteristics intended to be analyzed using ultrasound, e.g., to determine a fingerprint. Various embodiments of the ultrasonic receivers disclosed herein may benefit from one or more of the following advantages compared to conventional ultrasonic receivers: reduced power consumption, reduced die area requirements, and reduced cost due to the use of a more efficient architecture.

Some embodiments disclosed herein may be particularly suitable for ultrasonic fingerprint sensing for mobile devices. Mobile devices (or sometimes referred to as handheld devices) within the context of this disclosure include electronic devices which can be held by one or more hands of a user or users (the electronic devices can be completely mobile, and the electronic devices can be tethered to other electronics). Mobile devices can include mobile phones, tablets, laptops, portable speakers, wearable electronics, etc. However, ultrasonic device arrangements described herein are not limited to mobile fingerprint applications and are also applicable to ultrasonic sensors in general, e.g., to ultrasonic sensors not used for fingerprint applications, and/or to ultrasonic sensors used in scenarios where the mobility is limited. Furthermore, embodiments of circuits configured to integrate electrical signals in analog domain prior to being converted to digital domain for further processing are applicable to sensors other than ultrasound sensors, such as optical sensors, electro-chemical sensors, etc.

As will be appreciated by one skilled in the art, aspects of the present disclosure, in particular various aspects of ultrasonic devices proposed herein, may be embodied in various manners—e.g. as a system, a method, a computer program product, or a computer-readable storage medium. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Various functions described in this disclosure may be implemented as an algorithm executed by one or more hardware processing units, e.g. one or more microprocessors, of one or more computers. In various embodiments, different steps and portions of the steps of each of the methods described herein may be performed by different processing units. Furthermore, aspects of the present disclosure may take the form of a computer program product embodied in one or more computer-readable medium(s), preferably non-transitory, having computer-readable program code embodied, e.g., stored, thereon. In various embodiments, such a computer program may, for example, be downloaded (updated) to the existing devices and systems (e.g. to the existing magnetic sensors and/or their controllers, etc.) or be stored upon manufacturing of these devices and systems.

The following detailed description presents various descriptions of specific certain embodiments. However, the innovations described herein can be embodied in a multitude of different ways, for example, as defined and covered by the select examples. In the following description, reference is made to the drawings where like reference numerals can indicate identical or functionally similar elements. It will be understood that elements illustrated in the drawings are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

Other features and advantages of the disclosure will be apparent from the following description and the select examples.

Example Ultrasonic Sensor System

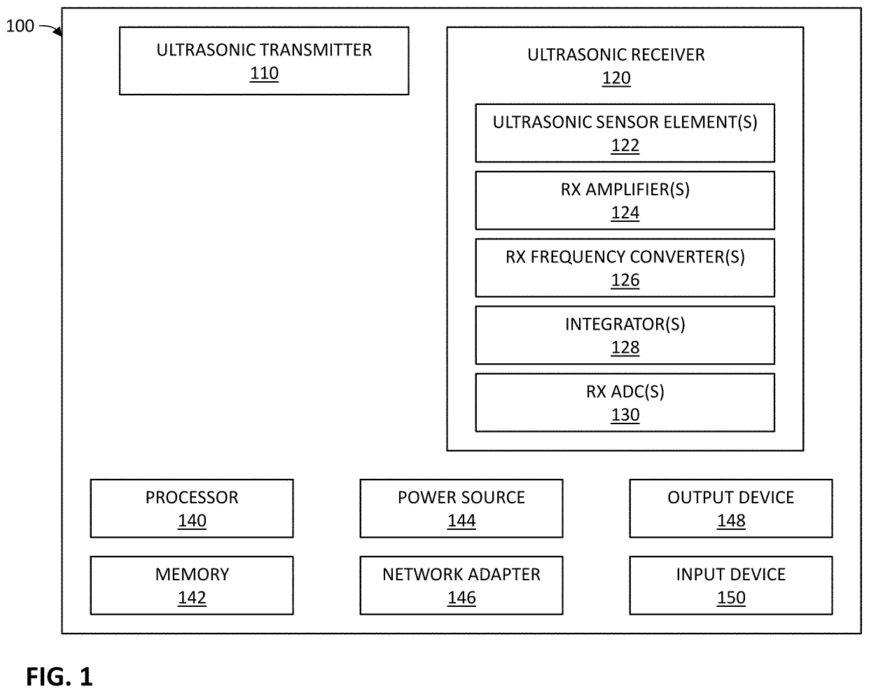

FIG. 1 provides a block diagram illustrating an example ultrasonic sensor system 100, according to some embodiments of the present disclosure. As shown in FIG. 1, the system 100 may include an ultrasonic transmitter 110 and an ultrasonic receiver 120.

The ultrasonic transmitter 110 may be configured to generate ultrasonic signals (e.g., acoustic waves) to be transmitted so that they interact with an object to be analyzed. Although details of the ultrasonic transmitter 110 are not shown in FIG. 1, in some embodiments, the ultrasonic transmitter may include a DAC, running at a clock frequency Fs, configured to generate an electrical signal, e.g., a sine wave, which is then provided to a driver of the ultrasonic transmitter 110, enabling the transmitter 110 to transmit an ultrasonic signal in the form of acoustic waves, indicative of the electrical signal generated by the DAC.

As shown in FIG. 1, the ultrasonic receiver 120 may include one or more ultrasonic sensor elements 122, one or more RX amplifiers 124, one or more RX frequency converters 126, one or more integrators 128, and one or more RX ADCs, where the abbreviation “RX” (receive) is used to indicate that components included in a receiver of a sensor system. In some embodiments, analogous components may be included in a transmitter, in which can they may be referred to as “TX” (transmit) components. For example, although not specifically shown, the transmitter 110 may include one or more TX amplifiers, one or more frequency converters, and one or more TX DACs configured to perform analogous functionality but on the transmitter side, e.g., as comparable to a wireless radio frequency (RF) communication system.

The one or more ultrasonic sensor elements 122, such as PZTs, configured to sense ultrasonic signals incident thereon and to generate electrical signals (e.g., current signals) indicative of the sensed ultrasonic signals. In some embodiments, a plurality of the ultrasonic sensor elements 122 may be arranged in an array of rows and columns. In some embodiments, the ultrasonic sensor elements 122 may be arranged in a fully addressed 2D arrays. In other embodiments, the ultrasonic sensor elements 122 may be arranged in 2D row-column-addressed arrays where individual ultrasonic sensor elements 122 may be addressed by their row or column index, and where each row and column in the array may act as one large element.

In some implementations, the same ultrasonic sensor elements 122 may also be used to transmit ultrasonic signals to begin with, which signals may then interact with the object being analyzed and be reflected from said object, so that the reflected ultrasonic signals are then received by the ultrasonic sensor elements 122. Thus, in such implementations, the ultrasonic sensor elements 122 may be shared between the ultrasonic receiver 120 and the ultrasonic transmitter 110.

In some embodiments, the ultrasonic sensor elements 122 may be provided on a die separate from a die that may house one or more of the one or more RX amplifiers 124, the one or more RX frequency converters 126, the integrators 128, and the one or more RX ADCs 130. In other embodiments, any two or more of these components may be provided on a single die.

In some embodiments, the one or more RX amplifiers 124 may include LNAs, which may be configured to amplify very low-power electrical signals generated by the ultrasonic sensor elements 122 as a result of receiving the ultrasonic signals, without significantly degrading its signal-to-noise ratio. In some embodiments, the one or more RX amplifiers 124 may include transimpedance amplifiers (TIAs), which may be configured to convert current signals generated by the ultrasonic sensor elements 122 as a result of receiving the ultrasonic signals, to voltage signals. Although the RX amplifiers may be referred to herein as “LNAs,” it is to be understood that, in some embodiments, the functionality of a TIA may be included in an LNA.

In general, the ultrasonic receiver 120 of the system 100 may include a plurality of ultrasonic sensor elements 122 and one of more RX amplifiers 124. In some embodiments, a single RX amplifier 124 may be shared among multiple ultrasonic sensor elements 122, e.g., in a time-division multiplex manner, which may be beneficial in terms of preserving die area by sharing said RX amplifier. In other embodiments, each ultrasonic sensor element 122 may be associated with a corresponding individual RX amplifier 124, which may be beneficial in terms of ability to perform parallel amplification and/or conversion of currents from various ultrasonic sensor elements 122.

The one or more RX frequency converters 126 may include frequency mixers configured to downconvert received signals from a higher-frequency signal to a lower-frequency signal. To that end, the RX frequency converters 126 are configured to mix a received (RX) signal, e.g., after the RX signal has been processed by the RX amplifier 124, with a local oscillator (LO) signal to generate a mixed signal. In some embodiments, the RX frequency converters 126 may be configured to perform quadrature signal processing, where, as is known in the art, “quadrature” is a term to describe a complex signal instead of a real signal, with in-phase and quadrature components corresponding, respectively, to real and imaginary parts of a complex signal. In such embodiments, a single RX frequency converter 126 may include two RX frequency converters—one configured to generate an in-phase component I of the complex downconverted signal, and another one configured to generate a quadrature component Q of the complex downconverted signal. Although not specifically shown in FIG. 1, the ultrasonic receive 120 may further include an I/Q to magnitude/phase converter(s) configured to convert the generated Cartesian (I/Q) representation of the complex downconverted RX signal S_{RX} (where S_{RX}=I+j*Q) to corresponding magnitude (A) and phase (cp) output components (where S_{RX}=A exp(jφ)), indicative of magnitude and phase of the signal S_{RX}.

In general, the ultrasonic receiver 120 of the system 100 may include a plurality of ultrasonic sensor elements 122 and one of more RX frequency converters 126. In some embodiments, each ultrasonic sensor element 122 may be associated with a corresponding individual RX frequency converter 126 (which, again, may include two separate frequency converters in some embodiments where quadrature processing is used), which may be beneficial in terms of ability to perform parallel frequency conversion of electrical signals received from various ultrasonic sensor elements 122. In other embodiments, a single RX frequency converter 126 may be shared among multiple ultrasonic sensor elements 122, e.g., in a time-division multiplex manner, which may be beneficial in terms of preserving die area by sharing said RX frequency converter.

The one or more integrators 128 are configured to generate the time integral of their input signals. In other words, a given integrator 128 is configured to accumulate an input quantity over a certain time period to produce a representative output.

In general, the ultrasonic receiver 120 of the system 100 may include a plurality of ultrasonic sensor elements 122 and one of more integrators 128. In some embodiments, each ultrasonic sensor element 122 may be associated with a corresponding individual integrator 128, which may be beneficial in terms of ability to perform parallel integration of electrical signals received from various ultrasonic sensor elements 122. In some embodiments where quadrature processing is used, separate integrators 128 may be used to integrate in-phase and quadrature components of a signal generated by a single ultrasonic sensor element 122. In other embodiments, a single integrator 128 may be shared among multiple ultrasonic sensor elements 122, e.g., in a time-division multiplex manner, which may be beneficial in terms of preserving die area by sharing said integrator.

The one or more RX ADCs 130 may be configured to convert electrical signals indicative of signals generated by the ultrasonic sensor elements 122 from analog to digital domain. In some embodiments, RX ADCs 130 may be configured to receive signals indicative of the outputs from the one or more integrators 128, and convert such signals to digital domain for further processor (post-processing).

In general, the ultrasonic receiver 120 of the system 100 may include a plurality of ultrasonic sensor elements 122 and one of more RX ADCs 130. In some embodiments, a single RX ADCs 130 may be shared among multiple ultrasonic sensor elements 122, e.g., in a time-division multiplex manner, which may be beneficial in terms of preserving die area by sharing said RX amplifier. In other embodiments, each ultrasonic sensor element 122 may be associated with a corresponding individual RX ADCs 130, which may be beneficial in terms of ability to perform parallel analog-to-digital conversion of signals from various ultrasonic sensor elements 122.

As further shown in FIG. 1, in various embodiments, the system 100 may also include one or more of a processor 140, a memory 142, a power source 144, an output device 148, an input device 150, and a network adapter 146.

In some embodiments, the processor 140 can execute software or an algorithm to perform the activities as discussed in the present disclosure, in particular activities related to ultrasonic sensing using the ultrasonic sensor elements 122. For example, the processor 140 may be configured to communicatively couple any of the components of the ultrasonic receiver 120 and/or the ultrasonic sensor elements 122 to each other and/or to other system elements via one or more interconnects or buses. In another example, the processor 140 may be configured to control processing of the signals generated by the ultrasonic sensor elements 122 and/or control transmission of the ultrasonic signals by the ultrasonic transmitter 110. In various embodiments, the processor 140 may include any combination of hardware, software, or firmware providing programmable logic, including by way of non-limiting example a microprocessor, a digital signal processor (DSP), a field-programmable gate array (FPGA), a programmable logic array (PLA), an application specific integrated circuit (ASIC), or a virtual machine processor. The processor 140 may be communicatively coupled to the memory 142, for example in a direct-memory access (DMA) configuration, so that the processor 140 may read from or write to the memory 142. The memory 142 may include any suitable volatile or non-volatile memory technology, including double data rate (DDR) random access memory (RAM), synchronous RAM (SRAM), dynamic RAM (DRAM), flash, read-only memory (ROM), optical media, virtual memory regions, magnetic or tape memory, or any other suitable technology. Unless specified otherwise, any of the memory elements discussed herein should be construed as being encompassed within the broad term “memory.” The information being measured, processed, tracked or sent to or from the ultrasonic transmitter 110, the ultrasonic receiver 120, the ultrasonic sensor elements 122, the one or more RX amplifiers 124, the one or more RX frequency converters 126, the integrators 128, the one or more RX ADCs 130, the processor 140, the memory 142, the network adapter 146, the output device 148, or the input device 150 could be provided in any database, register, control list, cache, or storage structure, all of which can be referenced at any suitable timeframe. Any such storage options may be included within the broad term “memory” as used herein. Similarly, any of the potential processing elements, modules, and machines described herein should be construed as being encompassed within the broad term “processor.” Each of the elements shown in FIG. 1, e.g., the transmitter 110, the ultrasonic sensor elements 122, the RX amplifiers 124, or the processor 140, can also include suitable interfaces for receiving, transmitting, and/or otherwise communicating data or information in a network environment.

In certain example implementations, mechanisms for ultrasonic sensing using the ultrasonic sensor elements 122 as outlined herein may be implemented by logic encoded in one or more tangible media, which may be inclusive of non-transitory media, e.g., embedded logic provided in an ASIC, in DSP instructions, software (potentially inclusive of object code and source code) to be executed by a processor, or other similar machine, etc. In some of these instances, memory elements, such as the memory 142 shown in FIG. 1, can store data or information used for the operations described herein. This may include the memory elements being able to store software, logic, code, or processor instructions that are executed to carry out the activities described herein. A processor can execute any type of instructions associated with the data or information to achieve the operations detailed herein. In one example, the processors, such as e.g. the processor 140 shown in FIG. 1, could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., an FPGA, a DSP, an erasable programmable read-only memory (EPROM), an electrically erasable programmable read-only memory (EEPROM)) or an ASIC that includes digital logic, software, code, electronic instructions, or any suitable combination thereof.

The memory 142 may include one or more physical memory devices such as, for example, local memory and one or more bulk storage devices. The local memory may refer to RAM or other non-persistent memory device(s) generally used during actual execution of the program code. A bulk storage device may be implemented as a hard drive or other persistent data storage device. The memory 142 may also include one or more cache memories that provide temporary storage of at least some program code in order to reduce the number of times program code must be retrieved from the bulk storage device during execution.

The power source 144 may provide power to substantially all components of the system of FIG. 1. In some implementations, the power source 144 may include one or more battery units.

The network adapter 146 may also, optionally, be included within or coupled to the ultrasonic sensing system 100 to enable it to become coupled to other systems, computer systems, remote network devices, and/or remote storage devices through intervening private or public networks. The network adapter 146 may include a data receiver for receiving data that is transmitted by said systems, devices and/or networks to the ultrasonic sensing system 100, and a data transmitter for transmitting data from the ultrasonic sensing system 100 to said systems, devices and/or networks. Modems, cable modems, and Ethernet cards are examples of different types of the network adapter 146.

Input/output (I/O) devices depicted in FIG. 1 as an input device 150 and an output device 148, optionally, can be included within or coupled to the ultrasonic sensor system 100. Examples of input devices may include, but are not limited to, a keyboard, a pointing device such as a mouse, or the like. The input device 150 may be configured to receive e.g. user input regarding when ultrasonic measurements are to begin, what information is to be output as a result, and in which format. Examples of output devices may include, but are not limited to, a monitor or a display, speakers, or the like. In some embodiments, the output device 148 may be any type of screen display, such as plasma display, liquid crystal display (LCD), organic light emitting diode (OLED) display, electroluminescent (EL) display, or any other indicator, such as a dial, barometer, or LEDs. The output device 148 may be configured to show the result of the ultrasonic sensing performed in accordance with the disclosures herein. For example, the output device 148 may be configured to provide a graphical user interface and display graphical representation of a fingerprint determined using the ultrasonic sensing performed by the system 100. In some implementations, the system may include a driver (not shown) for the output device 148. Input and/or output devices may be coupled to the current measurement apparatus 102 or to the current measurement unit 104 either directly or through intervening I/O controllers.

In an embodiment, the input and the output devices may be implemented as a combined I/O device. An example of such a combined device is a touch sensitive display, also sometimes referred to as a “touch screen display” or simply “touch screen”. In such an embodiment, input to the device may be provided by a movement of a physical object, such as e.g. a stylus or a finger of a user, on or near the touch screen display.

In some embodiments, some or all of the processor 140, the memory 142, the power source 144, the network adapter 146, the output device 148, and the input device 150 may reside in the same integrated unit as any components of the ultrasonic transmitter 110 and/or any components of the ultrasonic receiver 120. In other embodiments, one or more of the processor 140, the memory 142, the power source 144, the network adapter 146, the output device 148, and the input device 150 may reside in a separate unit than any components of the ultrasonic transmitter 110 and/or any components of the ultrasonic receiver 120.

Example Ultrasonic Receiver with Integration in Analog Domain

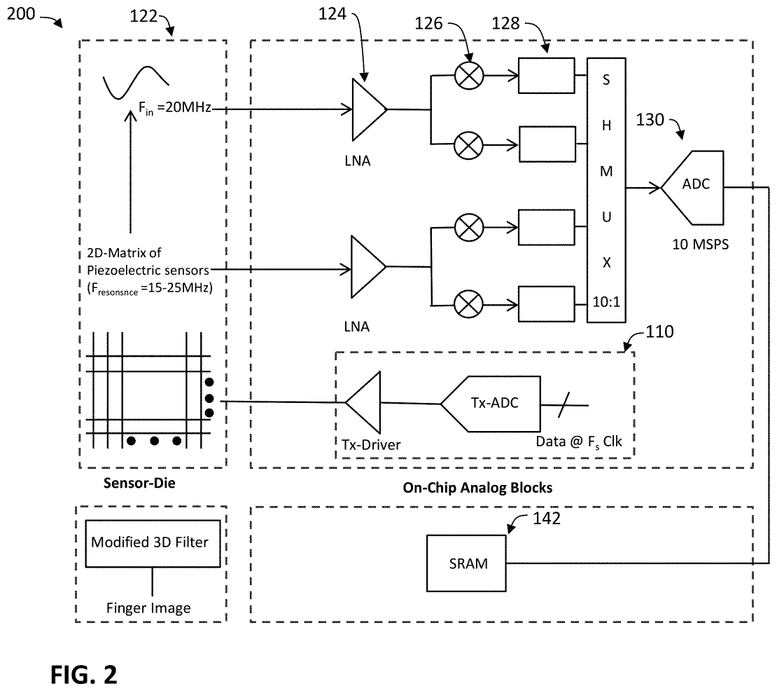

FIG. 2 provides a schematic illustration of an ultrasonic device 200, e.g., an ultrasonic receiver or a transceiver, with signal integration in analog domain, according to some embodiments of the present disclosure. The ultrasonic device 200 may be an example of the ultrasonic receiver 120 shown in FIG. 1, where FIG. 2 uses the same reference numerals as some of those shown in FIG. 1 to refer to the same or analogous/similar components. Descriptions of components of FIG. 1 having the same reference numerals as those shown in FIG. 2 are understood to be applicable to FIG. 2, and, therefore, in the interests of brevity, as not repeated here. In order to not clutter the drawing of FIG. 2, only 1 RX amplifier 124 is labeled with the reference numeral “124” although 2 such amplifiers are shown, only 1 RX frequency converter 126 is labeled with the reference numeral “126” although 4 such RX frequency converters (quadrature processing implementation) are shown, and only 1 integrator 128 is labeled with the reference numeral “128” although 4 such integrators are shown. In particular, FIG. 2 illustrates an implementation of 2 branches starting with the LNA 124, which may correspond to two rows of the 2D array of the ultrasonic sensor elements 122, but, in general, descriptions provided with respect to the ultrasonic device 200 are applicable to any number of rows.

As shown in FIG. 2, electrical signals indicative of the ultrasound waves detected by the ultrasonic sensor elements 122 (referred to in FIG. 2 as “2D-Matrix of Piezoelectric sensors”) of different rows are provided to respective LNAs 124 (each LNA 124 corresponding to a different row of sensor elements 122). Thus, example of FIG. 2 illustrates 2 different rows corresponding to 2 different branches, each branch starting with a different LNA 124. As can be seen from FIG. 2, the ultrasonic device 200 illustrates an embodiment where quadrature processing is used (although, in other embodiments of the ultrasonic device 200, quadrature processing may not be used). Namely, as shown in FIG. 2, in some embodiments, the branch of each of the LNAs 124 may include a pair of RX frequency converters 126, configured to perform frequency downconversion to generate, respectively, in-phase and quadrature components of the received signal, as described above. Furthermore, as also shown in FIG. 2, in such embodiments, a corresponding integrator 128 may be provided for each of the RX frequency converters 126 of a given branch. The first integrator 128 of each branch (e.g., the upper integrator 128 shown in each LNA branch) may be configured to integrate the in-phase components of the downconverted signal received from the first downconverted 126, while the second integrator 128 of each branch (e.g., the lower integrator 128 shown in each LNA branch) may be configured to integrate the quadrature components of the downconverted signal received from the first downconverted 126. As a result of integration, each integrator 128 may produce a single value (as opposed to a plurality of values of a sinusoidal signal), which may be a DC value and may be subsequently serialized with a multiplexer SHMUX shown in FIG. 2. The DC value may then be converted to digital domain by the ADC 130.

Performing the integration in analog domain (with or without using the quadrature processing as described above) may significantly reduce the requirements on the ADC 130, and allow sharing a single ADC 130 among multiple LNA branches. In some embodiments, the integration time may be programmable. In some embodiments, the integration time may be specified by start of integration (SOI) and end of integration (EOI) parameters. In some embodiments, the timing capability built into the integration may enable implementing ultrasound beam forming on the ADC output data. In some embodiments, different windows with skewed timing are used to generate multiple data frames which are then combined to generate final image by applying beamforming technique.

Example Operation of an Ultrasonic Receiver with Integration in Analog Domain

In some embodiments, the device 200 may include 5 amplifier slices (e.g., 5 branches that include the amplifier 124), and the entire analog front-end (AFE) may include a plurality of such blocks, e.g., 4 such blocks with a plurality of amplifier slices in each block.

In some embodiments, the device 200 may operate as follows. After an ultrasound transmitter is excited, e.g., at a frequency close to the resonance of the sensor elements 122, a current signal generated by a given sensor element 122 may be received by the associated amplifier 124 and converted into a voltage signal. Although not specifically shown in FIG. 2, a voltage-to-current conversion stage may follows the amplifier 124 and may convert the voltage produced by the amplifier 124 back to current. The current signal may then be mixed, e.g., by corresponding mixers 126, with I & Q phases of clock with frequency that may, e.g., be substantially the same as the excitation frequency used to excite the ultrasound transmitter, and the output of the two mixers 126 may then integrated by corresponding integrators 128 over a certain time period, e.g., over a pre-set time (e.g., t1 to t2). The integrated output may then be digitized using the ADC 130. In some embodiments, the ADC 130 may be shared between multiple amplifier slices.

In various embodiments, the entire process may be repeated with different start of integration time and integration time window to gather data for RX beam forming.

In some embodiments, the integration by the integrators 128 may be performed as follows. At the beginning, the ultrasound transmitter (TX) may be on, then the TX may turn off. After a certain time after the TX is turned on, e.g., about 640 nanoseconds after the TX turns on, the integrators 128 may start to integrate the signals provided thereto. In some embodiments, the start of integration and/or the end-of integration may be programmable.

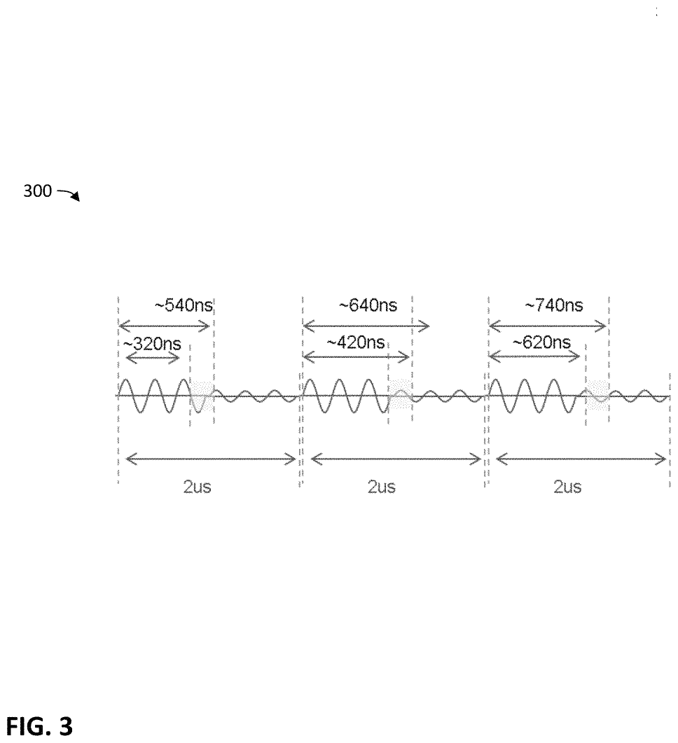

In some embodiments, the ultrasound device 200 may be configured with the ability to change integration timing from one sample to the next on the same sensor channel. In some such embodiments, the ultrasound device 200 may be configured to not take sample 100 nanoseconds apart in the same scan, but rather in different scans. When an object being evaluated, e.g., a finger, is stationary, the data may be as good as obtained from the same scan. In some embodiments, the integrator 128 may be configured to work as a “moving average” low-pass filter (LPF). In some such embodiments, the ultrasound device 200 may be configured to collect enough samples to still average a plurality of times, e.g., 6 times, e.g., to reduce noise. In some embodiments, the ultrasound device 200 may be configured to change the window location als, e.g., so that the sample may trail the moving average. In some embodiments, the ultrasound device 200 may be configured so that the width of moving average can be independent of sample-delay. For example, as shown in FIG. 3, the ultrasound device 200 may be configured to have 3 different location for time windows, e.g., with the same window width. In some embodiments, for windows between about 500 and 800 nanoseconds, less samples, e.g., only 4 samples/pixel, may be used/saved.

One benefit of the approach described herein may include easier software implementation, e.g., because less input data may be used (e.g., a plurality, e.g., 3-4 samples/pixels may be used), because less filtering inside software as low pass filtering is already being done in analog (e.g., the integrator may work as a moving average LPF, and/or because certain processors may be configured to perform all of the associated processing very quickly, e.g., at less than about 100 milliseconds per image. Another benefit of the approach described herein may include reduced SRAM requirements and processing requirements. For example, for 500 ns-800 ns, only 4 samples/pixel may need to be saved, which reduces SRAM requirement. Yet another benefit of the approach described herein may include relaxed requirements on the AFE because the approach may allow reducing area and power. In some embodiments, the ADC 130 may be configured to operate at about 10 MSPS and have an SNOB of about 10 bits.

Other sensor arrays with integration in analog domain

As briefly described above, embodiments of the present disclosure are not limited to ultrasonic device arrangements and may use with sensors other than ultrasonic sensors. To that end, descriptions provided above with reference to “ultrasonic” components are equally applicable to corresponding components for sensors other than ultrasonic sensors. For example, if the ultrasonic sensor elements 122, described above, are replaced with, e.g., optical sensor elements (e.g., photodetectors, e.g., avalanche photodetectors), then the ultrasonic transmitter 110 and the ultrasonic receiver 120, described above, could be, respectively, a transmitter and a receiver for transmitting and receiving optical signals instead of the ultrasound signals.

Select Examples

The following paragraphs provide some examples of various embodiments disclosed herein.

Example A1 provides an ultrasound device that includes an amplifier and an integrator. The amplifier is configured to receive a first signal generated by an ultrasound sensor, wherein the first signal is generated based on an ultrasound signal detected by the ultrasound sensor, and generate a second signal based on the first signal. The integrator is configured to generate a fourth signal by performing an integration of a third signal, where the third signal is based on the second signal, and wherein the third signal is an analog signal.

Example A2 provides the ultrasound device according to example A1, where the third signal is based on the second signal by being generated by performing a frequency downconversion of the second signal (e.g., the third signal is based on a downconverted version of the second signal).

Example A3 provides the ultrasound device according to examples A1 or A2, where the second signal is based on the first signal by being generated by amplifying the first signal and/or converting the first signal from a current signal to a voltage signal.

Example A4 provides the ultrasound device according to any one of the preceding examples A, where the amplifier is a low-noise amplifier.

Example A5 provides the ultrasound device according to any one of the preceding examples A, where the amplifier is a transimpedance amplifier.

Example A6 provides the ultrasound device according to any one of the preceding examples A, where the ultrasound sensor is a piezoelectric sensor.

Example A7 provides the ultrasound device according to any one of the preceding examples A, where the ultrasound signal detected by the ultrasound sensor includes at least one ultrasound signal component that has been reflected from an object.

Example A8 provides the ultrasound device according to example A7, where the at least one ultrasound signal component that has been reflected from the object is based on an ultrasound signal that has been transmitted by the ultrasound sensor.

Example A9 provides the ultrasound device according to any one of the preceding examples A, where the ultrasound signal detected by the ultrasound sensor is indicative of an ultrasound signal that has interacted with an object.

Example A10 provides the ultrasound device according to example A9, where the at least one ultrasound signal that has interacted with the object is based on an ultrasound signal that has been transmitted by the ultrasound sensor.

Example A11 provides the ultrasound device according to any one of examples A7-10, where the object is a finger.

Example A12 provides the ultrasound device according to any one of the preceding examples A, further including means configured to perform fingerprint detection and/or identification based on the fourth signal.

Example A13 provides the ultrasound device according to any one of the preceding examples A, further including an analog-to-digital converter configured to convert the fourth signal to a digital signal.

Example A14 provides the ultrasound device according to any one of the preceding examples A, where the fourth signal is a direct current (DC) signal.

Example A15 provides the ultrasound device according to any one of the preceding examples A, where the third signal is an alternating current (AC) signal.

Example A16 provides a method of operating the ultrasound device according to any one of the preceding examples A.

Example A17 provides a non-transitory computer-readable storage medium, storing instructions configured to, when executed on a processor, carry out a method of operating the ultrasound device according to any one of the preceding examples A.

Example A18 provides a computer program product including software code portions configured to, when executed on a processor, carry out a method of operating the ultrasound device according to any one of the preceding examples A.

Example B1 provides an ultrasound device that includes a first amplifier and a second amplifier. The first amplifier is configured to receive a first amplifier input signal, where the first amplifier input signal is based on a signal generated by a first row of ultrasonic sensor elements, and generate a first amplifier output signal based on the first amplifier input signal. The second amplifier is configured to receive a second amplifier input signal, where the second amplifier input signal is based on a signal generated by a second row of ultrasonic sensor elements, and generate a second amplifier output signal based on the second amplifier input signal. The device further includes a first integrator and a second integrator. The first integrator is configured to integrate a first analog signal to produce a first analog value, where the first analog signal is based on the first amplifier output signal. The second integrator is configured to integrate a second analog signal to produce a second analog value, where the second analog signal is based on the second amplifier output signal. The device further includes an ADC, configured to convert the first analog value to a first digital value, and convert the second analog value to a second digital value.

Example B2 provides the ultrasound device according to example B1, where the ultrasound device further includes a first frequency converter, configured to convert a signal based on the first amplifier output signal from a higher-frequency first signal to a lower-frequency first signal, the first analog signal is based on the first amplifier output signal by being based on the lower-frequency first signal, the ultrasound device further includes a second frequency converter, configured to convert a signal based on the second amplifier output signal from a higher-frequency second signal to a lower-frequency second signal, and the second analog signal is based on the second amplifier output signal by being based on the lower-frequency second signal.

Example B3 provides the ultrasound device according to example B1, where the ultrasound device further includes a first in-phase downconverter, configured to generate a first in-phase downconverted signal based on the first amplifier output signal. The ultrasound device further includes a first quadrature downconverter, configured to generate a first quadrature downconverted signal based on the first amplifier output signal. In such a device, the first integrator is a first in-phase integrator, the first analog signal is a first analog in-phase signal, the first analog value is a first analog in-phase value, the first analog in-phase signal is based on the first amplifier output signal by being based on the first in-phase downconverted signal, and the ultrasound device further includes a first quadrature integrator, configured to integrate a first quadrature signal to produce a first analog quadrature value, where the first analog quadrature signal is based on the first amplifier output signal by being based on the first quadrature downconverted signal.

Example B4 provides the ultrasound device according to example B3, where the ultrasound device further includes a second in-phase downconverter, configured to generate a second in-phase downconverted signal based on the second amplifier output signal, the ultrasound device further includes a second quadrature downconverter, configured to generate a second quadrature downconverted signal based on the second amplifier output signal, the second integrator is a second in-phase integrator, the second analog signal is a second analog in-phase signal, the second analog value is a second analog in-phase value, the second analog in-phase signal is based on the second amplifier output signal by being based on the second in-phase downconverted signal, and the ultrasound device further includes a second quadrature integrator, configured to integrate a second quadrature signal to produce a second analog quadrature value, where the second analog quadrature signal is based on the second amplifier output signal by being based on the second quadrature downconverted signal.

Example B5 provides the ultrasound device according to any one of the preceding examples B, where each of the first analog signal and the second analog signal is an AC signal, and each of the first analog value and the second analog value is a constant value.

Example B6 provides the ultrasound device according to any one of the preceding examples B, where the signal generated by the first row of ultrasonic sensor elements, the first amplifier input signal, the first amplifier output signal, the first analog signal, the signal generated by the second row of ultrasonic sensor elements, the second amplifier input signal, the second amplifier output signal, and the second analog signal are signals in analog domain.

Example B7 provides the ultrasound device according to any one of the preceding examples B, where the signal generated by the first row of ultrasonic sensor elements, the first amplifier input signal, the first amplifier output signal, the first analog signal, the signal generated by the second row of ultrasonic sensor elements, the second amplifier input signal, the second amplifier output signal, and the second analog signal are AC signals.

Example B8 provides the ultrasound device according to any one of the preceding examples B, where no analog-to-digital conversion is performed on signals based on the signal generated by the first row of ultrasonic sensor elements until the first analog value is converted to the first digital value, and no analog-to-digital conversion is performed on signals based on the signal generated by the second row of ultrasonic sensor elements until the second analog value is converted to the second digital value.

Example B9 provides the ultrasound device according to any one of the preceding examples B, further including a multiplexer, configured to multiplex using the ADC to convert both the first analog value and the second analog value.

Example B10 provides the ultrasound device according to any one of the preceding examples B, further including the first row of ultrasonic sensor elements and the second row of ultrasonic sensor elements.

Example B11 provides an ultrasound device that includes one or more amplifiers, configured to generate a plurality of amplifier output signals based on a plurality of signals generated by ultrasonic sensor elements; one or more integrators, configured to, for each amplifier output signal of the plurality of amplifier output signals, integrate the amplifier output signal to generate a value; and one or more analog-to-digital converters, configured to convert the value from analog to digital domain for each amplifier output signal of the plurality of amplifier output signals.

Example B12 provides the ultrasound device according to example B11, where each amplifier output signal of the plurality of amplifier output signals is based on a signal generated by a different row of the ultrasonic sensor elements.

Example B13 provides the ultrasound device according to examples B11 or B12, further including the ultrasonic sensor elements.

Example B14 provides an ultrasound device that includes an amplifier, configured to receive a first signal generated by an ultrasound sensor, where the first signal is generated based on an ultrasound signal detected by the ultrasound sensor, and generate a second signal based on the first signal. The device further includes an integrator, configured to generate a fourth signal by performing an integration of a third signal, where the third signal is based on the second signal, and where the third signal is an analog signal.

Example B15 provides the ultrasound device according to example B11, where the third signal is based on the second signal by being generated by performing a frequency downconversion of the second signal (e.g., the third signal is based on a downconverted version of the second signal).

Example B16 provides the ultrasound device according to examples B14 or B15, where the second signal is based on the first signal by being generated by one or more of amplifying the first signal and converting the first signal from a current signal to a voltage signal.

Example B17 provides the ultrasound device according to any one of examples B14-B16, further including a processor, configured to perform one or more of fingerprint detection and fingerprint identification based on the fourth signal.

Example B18 provides the ultrasound device according to any one of examples B14-B17, further including an ADC configured to convert the fourth signal to a digital signal.

Example B19 provides the ultrasound device according to any one of examples B14-B18, where the fourth signal is a DC signal.

Example B20 provides the ultrasound device according to any one of examples B14-B19, where the third signal is an AC signal.

Example C1 provides an electronic device that includes a first amplifier and a second amplifier. The first amplifier is configured to receive a first amplifier input signal, where the first amplifier input signal is based on a signal generated by a first row of sensor elements, and generate a first amplifier output signal based on the first amplifier input signal. The second amplifier is configured to receive a second amplifier input signal, where the second amplifier input signal is based on a signal generated by a second row of sensor elements, and generate a second amplifier output signal based on the second amplifier input signal. The device further includes a first integrator and a second integrator. The first integrator is configured to integrate a first analog signal to produce a first analog value, where the first analog signal is based on the first amplifier output signal. The second integrator is configured to integrate a second analog signal to produce a second analog value, where the second analog signal is based on the second amplifier output signal. The device further includes an ADC, configured to convert the first analog value to a first digital value, and convert the second analog value to a second digital value.

Example C2 provides the electronic device according to example C1, where the electronic device further includes a first frequency converter, configured to convert a signal based on the first amplifier output signal from a higher-frequency first signal to a lower-frequency first signal, the first analog signal is based on the first amplifier output signal by being based on the lower-frequency first signal, the electronic device further includes a second frequency converter, configured to convert a signal based on the second amplifier output signal from a higher-frequency second signal to a lower-frequency second signal, and the second analog signal is based on the second amplifier output signal by being based on the lower-frequency second signal.

Example C3 provides the electronic device according to example C1, where the electronic device further includes a first in-phase downconverter, configured to generate a first in-phase downconverted signal based on the first amplifier output signal. The electronic device further includes a first quadrature downconverter, configured to generate a first quadrature downconverted signal based on the first amplifier output signal. In such a device, the first integrator is a first in-phase integrator, the first analog signal is a first analog in-phase signal, the first analog value is a first analog in-phase value, the first analog in-phase signal is based on the first amplifier output signal by being based on the first in-phase downconverted signal, and the electronic device further includes a first quadrature integrator, configured to integrate a first quadrature signal to produce a first analog quadrature value, where the first analog quadrature signal is based on the first amplifier output signal by being based on the first quadrature downconverted signal.

Example C4 provides the electronic device according to example C3, where the electronic device further includes a second in-phase downconverter, configured to generate a second in-phase downconverted signal based on the second amplifier output signal, the electronic device further includes a second quadrature downconverter, configured to generate a second quadrature downconverted signal based on the second amplifier output signal, the second integrator is a second in-phase integrator, the second analog signal is a second analog in-phase signal, the second analog value is a second analog in-phase value, the second analog in-phase signal is based on the second amplifier output signal by being based on the second in-phase downconverted signal, and the electronic device further includes a second quadrature integrator, configured to integrate a second quadrature signal to produce a second analog quadrature value, where the second analog quadrature signal is based on the second amplifier output signal by being based on the second quadrature downconverted signal.

Example C5 provides the electronic device according to any one of the preceding examples C, where each of the first analog signal and the second analog signal is an AC signal, and each of the first analog value and the second analog value is a constant value.

Example C6 provides the electronic device according to any one of the preceding examples C, where the signal generated by the first row of sensor elements, the first amplifier input signal, the first amplifier output signal, the first analog signal, the signal generated by the second row of sensor elements, the second amplifier input signal, the second amplifier output signal, and the second analog signal are signals in analog domain.

Example C7 provides the electronic device according to any one of the preceding examples C, where the signal generated by the first row of sensor elements, the first amplifier input signal, the first amplifier output signal, the first analog signal, the signal generated by the second row of sensor elements, the second amplifier input signal, the second amplifier output signal, and the second analog signal are AC signals.

Example C8 provides the electronic device according to any one of the preceding examples C, where no analog-to-digital conversion is performed on signals based on the signal generated by the first row of sensor elements until the first analog value is converted to the first digital value, and no analog-to-digital conversion is performed on signals based on the signal generated by the second row of sensor elements until the second analog value is converted to the second digital value.

Example C9 provides the electronic device according to any one of the preceding examples C, further including a multiplexer, configured to multiplex using the ADC to convert both the first analog value and the second analog value.

Example C10 provides the electronic device according to any one of the preceding examples C, further including the first row of sensor elements and the second row of sensor elements.

Example C11 provides an electronic device that includes one or more amplifiers, configured to generate a plurality of amplifier output signals based on a plurality of signals generated by sensor elements; one or more integrators, configured to, for each amplifier output signal of the plurality of amplifier output signals, integrate the amplifier output signal to generate a value; and one or more analog-to-digital converters, configured to convert the value from analog to digital domain for each amplifier output signal of the plurality of amplifier output signals.

Example C12 provides the electronic device according to example C11, where each amplifier output signal of the plurality of amplifier output signals is based on a signal generated by a different row of the sensor elements.

Example C13 provides the electronic device according to examples C11 or C12, further including the sensor elements.

Example C14 provides an electronic device that includes an amplifier, configured to receive a first signal generated by a sensor, where the first signal is generated based on a signal detected by the sensor, and generate a second signal based on the first signal. The device further includes an integrator, configured to generate a fourth signal by performing an integration of a third signal, where the third signal is based on the second signal, and where the third signal is an analog signal.

Example C15 provides the electronic device according to example C11, where the third signal is based on the second signal by being generated by performing a frequency downconversion of the second signal (e.g., the third signal is based on a downconverted version of the second signal).

Example C16 provides the electronic device according to examples C14 or C15, where the second signal is based on the first signal by being generated by one or more of amplifying the first signal and converting the first signal from a current signal to a voltage signal.

Example C17 provides the electronic device according to any one of examples C14-C16, further including a processor, configured to perform one or more of fingerprint detection and fingerprint identification based on the fourth signal.

Example C18 provides the electronic device according to any one of examples C14-C17, further including an ADC configured to convert the fourth signal to a digital signal.

Example C19 provides the electronic device according to any one of examples C14-C18, where the fourth signal is a DC signal.

Example C20 provides the electronic device according to any one of examples C14-C19, where the third signal is an AC signal.

Other Implementation Notes, Variations, and Applications

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

In one example embodiment, any number of electrical circuits of the FIGS. may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of DSPs, microprocessors, supporting chipsets, etc.), computer-readable non-transitory memory elements, etc. can be suitably coupled to the board based on particular configuration needs, processing demands, computer designs, etc. Other components such as external storage, additional sensors, controllers for audio/video display, and peripheral devices may be attached to the board as plug-in cards, via cables, or integrated into the board itself. In various embodiments, the functionalities described herein may be implemented in emulation form as software or firmware running within one or more configurable (e.g., programmable) elements arranged in a structure that supports these functions. The software or firmware providing the emulation may be provided on non-transitory computer-readable storage medium comprising instructions to allow a processor to carry out those functionalities.

In another example embodiment, the electrical circuits of the FIGS. may be implemented as stand-alone modules (e.g., a device with associated components and circuitry configured to perform a specific application or function) or implemented as plug-in modules into application specific hardware of electronic devices. Note that particular embodiments of the present disclosure may be readily included in a system on chip (SOC) package, either in part, or in whole. An SOC represents an IC that integrates components of a computer or other electronic system into a single chip. It may contain digital, analog, mixed-signal, and often radio frequency functions: all of which may be provided on a single chip substrate. Other embodiments may include a multi-chip-module (MCM), with a plurality of separate ICs located within a single electronic package and configured to interact closely with each other through the electronic package. In various other embodiments, the digital filters may be implemented in one or more silicon cores in ASICs, FPGAs, and other semiconductor chips.

It is also imperative to note that all of the specifications, dimensions, and relationships outlined herein (e.g., the number of processors, logic operations, etc.) have only been offered for purposes of example and teaching only. Such information may be varied considerably without departing from the spirit of the present disclosure, or the scope of the appended claims. The specifications apply only to one non-limiting example and, accordingly, they should be construed as such. In the foregoing description, example embodiments have been described with reference to particular arrangements of components. Various modifications and changes may be made to such embodiments without departing from the scope of the appended claims. The description and drawings are, accordingly, to be regarded in an illustrative rather than in a restrictive sense.

Note that with the numerous examples provided herein, interaction may be described in terms of two, three, four, or more electrical components. However, this has been done for purposes of clarity and example only. It should be appreciated that the system can be consolidated in any suitable manner. Along similar design alternatives, any of the illustrated components, modules, and elements of the FIGS. may be combined in various possible configurations, all of which are clearly within the broad scope of the present disclosure. In certain cases, it may be easier to describe one or more of the functionalities of a given set of flows by only referencing a limited number of electrical elements. It should be appreciated that the electrical circuits of the FIGS. and its teachings are readily scalable and can accommodate a large number of components, as well as more complicated/sophisticated arrangements and configurations. Accordingly, the examples provided should not limit the scope or inhibit the broad teachings of the electrical circuits as potentially applied to a myriad of other architectures.

Note that in the present disclosure, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments.

It is also important to note that the functions related to ultrasonic and other types of sensing described herein, e.g. those summarized in the one or more figures presented herein, illustrate only some of the possible functions that may be executed by, or within, the ultrasonic sensor system illustrated in the drawings or other sensor systems described herein. Some of these operations may be deleted or removed where appropriate, or these operations may be modified or changed considerably without departing from the scope of the present disclosure. In addition, the timing of these operations may be altered considerably. The preceding operational flows have been offered for purposes of example and discussion. Substantial flexibility is provided by embodiments described herein in that any suitable arrangements, chronologies, configurations, and timing mechanisms may be provided without departing from the teachings of the present disclosure.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. Note that all optional features of the apparatus described above may also be implemented with respect to the method or process described herein and specifics in the examples may be used anywhere in one or more embodiments.

1. An ultrasound device, comprising:
a first amplifier, configured to:
receive a first amplifier input signal, where the first amplifier input signal is based on a signal generated by a first row of ultrasonic sensor elements, and
generate a first amplifier output signal based on the first amplifier input signal; a second amplifier, configured to:
receive a second amplifier input signal, where the second amplifier input signal is based on a signal generated by a second row of ultrasonic sensor elements, and
generate a second amplifier output signal based on the second amplifier input signal;
a first integrator, configured to integrate a first analog signal to produce a first analog value, where the first analog signal is based on the first amplifier output signal;
a second integrator, configured to integrate a second analog signal to produce a second analog value, where the second analog signal is based on the second amplifier output signal; and
an analog-to-digital converter, configured to:
convert the first analog value to a first digital value, and
convert the second analog value to a second digital value.

2. The ultrasound device according to claim 1, wherein:
the ultrasound device further includes a first frequency converter, configured to convert a signal based on the first amplifier output signal from a higher-frequency first signal to a lower-frequency first signal,
the first analog signal is based on the first amplifier output signal by being based on the lower-frequency first signal,
the ultrasound device further includes a second frequency converter, configured to convert a signal based on the second amplifier output signal from a higher-frequency second signal to a lower-frequency second signal, and
the second analog signal is based on the second amplifier output signal by being based on the lower-frequency second signal.

3. The ultrasound device according to claim 1, wherein:
the ultrasound device further includes a first in-phase downconverter, configured to generate a first in-phase downconverted signal based on the first amplifier output signal,
the ultrasound device further includes a first quadrature downconverter, configured to generate a first quadrature downconverted signal based on the first amplifier output signal,
the first integrator is a first in-phase integrator,
the first analog signal is a first analog in-phase signal,
the first analog value is a first analog in-phase value,
the first analog in-phase signal is based on the first amplifier output signal by being based on the first in-phase downconverted signal, and
the ultrasound device further includes a first quadrature integrator, configured to integrate a first quadrature signal to produce a first analog quadrature value, where the first analog quadrature signal is based on the first amplifier output signal by being based on the first quadrature downconverted signal.

4. The ultrasound device according to claim 3, wherein:
the ultrasound device further includes a second in-phase downconverter, configured to generate a second in-phase downconverted signal based on the second amplifier output signal,
the ultrasound device further includes a second quadrature downconverter, configured to generate a second quadrature downconverted signal based on the second amplifier output signal,
the second integrator is a second in-phase integrator,
the second analog signal is a second analog in-phase signal,
the second analog value is a second analog in-phase value,
the second analog in-phase signal is based on the second amplifier output signal by being based on the second in-phase downconverted signal, and
the ultrasound device further includes a second quadrature integrator, configured to integrate a second quadrature signal to produce a second analog quadrature value, where the second analog quadrature signal is based on the second amplifier output signal by being based on the second quadrature downconverted signal.

5. The ultrasound device according to claim 1, wherein:
each of the first analog signal and the second analog signal is an AC signal, and
each of the first analog value and the second analog value is a constant value.

6. The ultrasound device according to claim 1, wherein the signal generated by the first row of ultrasonic sensor elements, the first amplifier input signal, the first amplifier output signal, the first analog signal, the signal generated by the second row of ultrasonic sensor elements, the second amplifier input signal, the second amplifier output signal, and the second analog signal are signals in analog domain.

7. The ultrasound device according to claim 1, wherein the signal generated by the first row of ultrasonic sensor elements, the first amplifier input signal, the first amplifier output signal, the first analog signal, the signal generated by the second row of ultrasonic sensor elements, the second amplifier input signal, the second amplifier output signal, and the second analog signal are alternating current (AC) signals.

8. The ultrasound device according to claim 1, wherein:
no analog-to-digital conversion is performed on signals based on the signal generated by the first row of ultrasonic sensor elements until the first analog value is converted to the first digital value, and
no analog-to-digital conversion is performed on signals based on the signal generated by the second row of ultrasonic sensor elements until the second analog value is converted to the second digital value.

9. The ultrasound device according to claim 1, further comprising a multiplexer, configured to multiplex using the ADC to convert both the first analog value and the second analog value.

10. The ultrasound device according to claim 1, further comprising the first row of ultrasonic sensor elements and the second row of ultrasonic sensor elements.

11. An ultrasound device, comprising:
one or more amplifiers, configured to generate a plurality of amplifier output signals based on a plurality of signals generated by ultrasonic sensor elements;
one or more integrators, configured to, for each amplifier output signal of the plurality of amplifier output signals, integrate the amplifier output signal to generate a value; and
one or more analog-to-digital converters, configured to convert the value from analog to digital domain for each amplifier output signal of the plurality of amplifier output signals.

12. The ultrasound device according to claim 11, wherein each amplifier output signal of the plurality of amplifier output signals is based on a signal generated by a different row of the ultrasonic sensor elements.

13. The ultrasound device according to claim 11, further comprising the ultrasonic sensor elements.

14. An ultrasound device, comprising:
an amplifier, configured to:
receive a first signal generated by an ultrasound sensor, wherein the first signal is generated based on an ultrasound signal detected by the ultrasound sensor, and
generate a second signal based on the first signal; and
an integrator, configured to generate a fourth signal by performing an integration of a third signal, wherein the third signal is based on the second signal, and wherein the third signal is an analog signal.

15. The ultrasound device according to claim 11, wherein the third signal is based on the second signal by being generated by performing a frequency downconversion of the second signal (e.g., the third signal is based on a downconverted version of the second signal).

16. The ultrasound device according to claim 14, wherein the second signal is based on the first signal by being generated by one or more of amplifying the first signal and converting the first signal from a current signal to a voltage signal.

17. The ultrasound device according to claim 14, further comprising a processor, configured to perform one or more of fingerprint detection and fingerprint identification based on the fourth signal.

18. The ultrasound device according to claim 14, further comprising an analog-to-digital converter configured to convert the fourth signal to a digital signal.

19. The ultrasound device according to claim 14, wherein the fourth signal is a direct current (DC) signal.

20. The ultrasound device according to claim 14, wherein the third signal is an alternating current (AC) signal.
